(19) United States
(12) Patent Application Publication
(10) Pub. No.: US 2006/0044329 A1
(43) Pub. Date: Mar. 2, 2006

(54) Pixel structure in an electroluminescent display device

(75) Inventor: Coen Theodorus Hubertus Fransiscus Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/527,114

(22) PCT Filed: Aug. 4, 2003
(86) PCT No.: PCT/IB03/03411

§ 371 Date: Mar. 8, 2005

(30) Foreign Application Priority Data
Sep. 11, 2002 (NL) 1021427

(51) Int. Cl. G09G 5/02

(52) U.S. Cl. 345/695

(57) ABSTRACT

An electroluminescent device (200) for use, e.g., in a colour matrix display unit is presented. Picture elements comprise a plurality of electroluminescent sub-pixels (201, 202, 203) capable of emitting light when subject to electric current. The sub-pixels each area (211, 212, 213) and, for any pair of first and second sub-pixels in a picture element, the ratio between the first sub-pixel emissive area and the second sub-pixel emissive area is inversely proportional to the ratio between the degradation lifetime of said first sub-pixel and the degradation lifetime of the second sub-pixel.

### TECHNICAL FIELD

The present invention relates to a device comprising at least one picture element, the at least one picture element comprising a plurality of electroluminescent sub-pixels.

### BACKGROUND

Since their discovery in the early 1990's, light emitting devices utilizing electroluminescent material, organic material such as polymers as well as inorganic material, have been subject to very intense research and development efforts. Products including such devices and are now becoming widely available. Examples of such products include mobile communication terminals, PDA's etc that are equipped with monochrome or colour matrix display devices.

Major strides in the development of the electroluminescent devices have been taken in the field of reduction of drive voltages as well as in the field of increasing the efficiency of conversion of electric energy input to luminous energy emitted from the devices.

In a typical colour matrix display devices having electroluminescent light emitting diodes, each picture element (pixel) contains three sub-pixels. By utilizing different materials, organic material such as polymers or low molecular weight material, or inorganic material such as Phosphor, each capable of providing electroluminescence in the wavelength band corresponding to the primary colours, for the sub-pixels it is possible to generate a realistic colour picture. Electrical driving of the sub-pixels under control of an incoming video or graphics signal, an intensity per colour (i.e. per sub-pixel) is generated. The sum of the light output by sub-pixels gives the total brightness and hue of the pixel.

However, it is known that different electroluminescent materials have different lifetimes in terms of stress lifetimes at constant brightness. The material degrades, for example, via photo oxidation, electro oxidation as well as molecular chain reorientation and results in a reduced efficiency of converting input electric energy into luminous flux. Needless to say, the specific timescales for the degradation effects differ among the electroluminescent materials.

Whereas the lifetime of an electroluminescent material can be measured, simply, by considering the change of brightness of the device containing the material, the degradation lifetime also depends on the electric current density obtained in the electroluminescent material when feeding electric current to the device. It has been found that there is an inverse proportionality relation between current density and lifetime, i.e. by increasing the input current to a given organic material element by a factor of two, the degradation lifetime of the element is also reduced by a factor of two.

These, seemingly unavoidable degrading effects, results in a serious problem when constructing colour displays having picture elements with a plurality of sub-pixels that are made of different electroluminescent materials. The problem relies on the fact that, in colour display applications such as when providing a computer or other personal communication devices with a colour display, it is important to maintain a long-term balance of luminance between the sub-pixels in order to maintain the capability of the display to represent true colours and hues. In fact, the sub-pixels comprising the electroluminescent material with the shortest degradation timescale then governs the lifetime of a display.

An electroluminescent display apparatus according to prior art is disclosed in U.S. Pat. No. 6,366,025. There, the emissive area of R-, G- and B-sub-pixels in a picture element is selected to compensate for the sub-pixels having different emission efficiencies, given a situation where the electric current supplying the sub-pixels is such that the current density is maintained at a constant level for all sub-pixels.

### SUMMARY OF THE INVENTION

It is hence an object of the present invention to overcome problems related to prior art devices utilizing electroluminescent material.

A problem solved by the invention is how to extend the degradation lifetime of an electroluminescent device. Or, in other words, a problem of how to circumvent early burnout of one or more sub-pixels in picture elements of an electroluminescent device, and thereby extending the lifetime, is addressed by the invention.

A solution according to the invention as claimed below entails providing an electroluminescent device having sub-pixel arrangements capable of maintaining an acceptable luminance balance between the sub-pixels.

In some detail, an electroluminescent device according to the invention comprises at least one picture element, comprising a plurality of electroluminescent sub-pixels capable of emitting light when subject to electric current. The sub-pixels each have a degradation lifetime and an emissive area and, for any pair of first and second sub-pixels in a picture element, the ratio between the first sub-pixel emissive area and the second sub-pixel emissive area is inversely proportional to the ratio between the degradation lifetime of said first sub-pixel and the degradation lifetime of the second sub-pixel.

The effect of the invention is hence a circumvention of early burnout of sub-pixels in an electroluminescent device. The sub-pixels are arranged such that the emissive area of the sub-pixels scale inversely proportional with their expected lifetime. In other words, the sub-pixel made of the material having shortest degradation lifetime will have the largest area.

An advantage of the invention is that an extended lifetime of an electroluminescent device is obtained, at least in terms of a maintained luminance balance between sub-pixels of different colours, irrespective of the electric driving conditions. That is, the invention provides an extended display lifetime when the sub-pixels are subject to substantial variations in the electric current density, which is the case during normal operation of, e.g., a colour display unit comprising an electroluminescent device according to the invention.

Such normal operation entails typical use of a display showing random pictures having large variation of brightness between picture elements and since the inverse proportionality of current density and lifetime holds, it is possible to determine area ratios that holds throughout a substantial range of brightness of the display the pixels are being used.

In an espacenet abstract of JP10003971 an organic EL device having red green and blue sub-pixels of different area is disclosed. The ratio of the sub-pixel areas is not chosen in accordance with the lifetime but chosen to obtain white by applying the same voltage to the red green and blue sub-pixel.

According to a preferred embodiment of the invention, a picture element comprising at least a pair of sub-pixels, is considered and the area of the sub-pixels is calculated using a relation:

$$\frac{{A}_{1}}{{A}_{2}} = \frac{{γ}_{2}}{{γ}_{1}} \cdot \frac{{η}_{2}}{{η}_{1}} \cdot \frac{{α}_{1}}{{α}_{2}}$$

where γ, η, and α, with index 1 representing any first sub-pixel and index 2 representing any second sub-pixel, are respective material parameters, where the γ-parameter is a scaling factor which is the proportionality constant between on the one hand the efficiency divided by the brightness of the pixel and on the other hand the resulting lifetime of the pixel, the η-parameter is the efficiency of a material measured in Cd/A and is the proportionality constant between the amount of current through a pixel and the light being generated, and where the α-parameter defines the weight factor for the respective sub-pixel, or in other words of the total light emitted by a colour pixel a fraction α is emitted by the sub-pixel, where the light emitted by a color pixel is expressed in Cd.

Preferred selections of electroluminescent materials include both organic and inorganic materials. Among the organic materials, electroluminescent polymers as well as low molecular weight molecules are preferred choices.

Advantageous use of electroluminescent devices include both illumination devices and matrix display units of, e.g., passive or active type.

### BRIEF DESCRIPTION OF THE DRAWINGS

The invention will now be described in terms of preferred embodiments and with reference to the drawings, where:

FIG. 1 schematically shows an electronic device including a colour display device according to the invention.

FIG. 2 schematically shows a picture element comprising R-, G- and B-sub-pixels.

FIG. 3 schematically illustrates a picture element comprising a number of emissive sub-pixel area parts.

### PREFERRED EMBODIMENTS

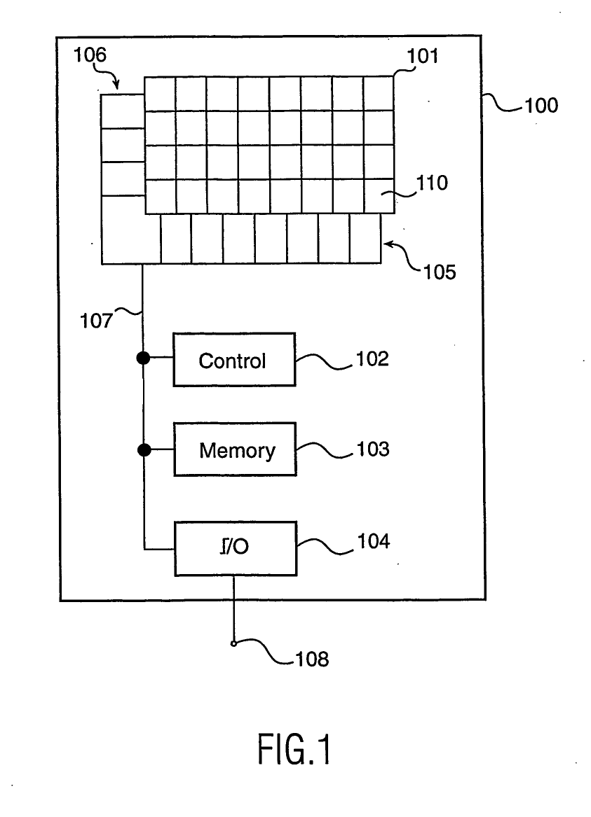

FIG. 1 shows an electronic device 100 comprising an electroluminescent colour display device 101 according to the present invention. The device 100 is intentionally illustrated in a generic manner in order to emphasize the fact that a display unit according to the invention is applicable in any electronic device such as a computer or a communication terminal, as the skilled person realizes.

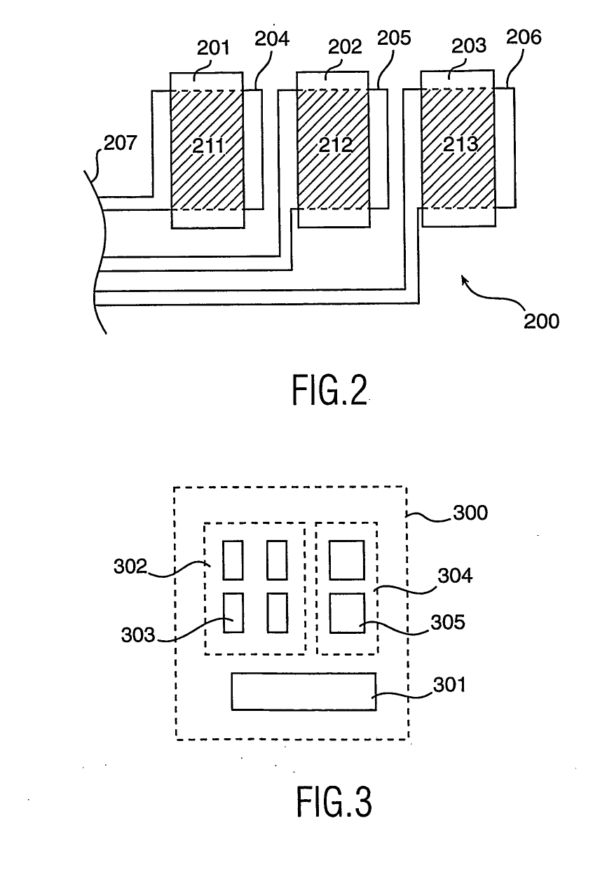

A control unit 102 utilizes contents of a memory unit 103 and exchanges information with, e.g., an external data source via a connector 108 of an input/output interface unit 104. Via a data bus 107 the control unit 102 provides signals to row and column signal feed lines 105, 106 feeding electric current to a matrix of picture elements 110 of the electroluminescent device 101. As the person skilled in the art understands, the picture elements 110 comprise a number of individual components, a few of which will be discussed further below in connection with FIG. 2. However, for clarity it should already here be pointed out that the picture elements 110 comprise electroluminescent polymer as well as anodes and cathodes, for example forming part of TFT (thin film transistor) circuitry. A passive matrix arrangement may also be used. Moreover, although only a polymer implementation will be described below, other types of electroluminescent materials can be used and these include both organic and inorganic materials. Among the organic materials, in addition to electroluminescent polymers, also low molecular weight molecules are preferred choices.

Turning now to FIG. 2, one single picture element 200 will be discussed. A first sub-pixel polymer patch 201, a second sub-pixel polymer patch 202 and a third sub-pixel polymer patch 203 are arranged above a respective first, second and third anode 204, 205, 206 forming part of a TFT circuit (not shown in detail) and connected to further circuitry as indicated by the interface 207. As the person skilled in the art will understand, additional circuitry is needed when constructing a display device. However, such circuitry is outside the scope of the present invention and will not be discussed further.

Each sub-pixel polymer patch 201, 202, 203 receives electric current via the respective anode 204, 205, 206. Thereby a respective emissive area 211, 212, 213 is obtained on the patches, providing the desired light emission.

FIG. 3 illustrates an example of a picture element 300 comprising three sub-pixels, a first 301, second 304 and a third sub-pixel 302. However, in contrast to the example described above in connection with FIG. 2, the sub-pixels 301, 304, 302 each comprises a different number of emissive area parts. The first sub-pixel 301 comprises one emissive area part 301, the second sub-pixel 304 comprises two emissive area parts 305 and the third sub-pixel 302 comprises four emissive area parts 303.

In the following, a calculation will be presented of how to derive area ratios in accordance with the equivalent lifetime concept according to the present invention. Note that the derivation will be illustrated by using a three colour/sub-pixel notation: R, G and B. First an index i is defined enumerating the sub-pixels R, G and B. Furthermore the area of the sub-pixel is defined by Aᵢ with the constraint Sum(Aᵢ)=A₀, where A₀ is the total area (which is light-emissive)of the picture element comprising the sub-pixels.

The deterioration lifetime T of an electroluminescent device scales with current density Iᵢ/Aᵢ with Iᵢ being the current through the sub-pixel in a manner defined by:

$${T}_{i} = {γ}_{i} \cdot \frac{{A}_{i}}{{I}_{i}}$$

where γ is a scaling factor which is the proportionality constant between on the one hand the efficiency divided by the brightness of the pixel and on the other hand the resulting lifetime of the pixel. The units are Ah/m². In other words γ determines the relation between lifetime

$${T}_{i} = {γ}_{i} \cdot \frac{{η}_{i}}{{B}_{i}}$$

and the brightness that the pixel is set at. Translated to brightness Bᵢ in units of cd/m² we have:
where use has been made of the relation:

$${B}_{i} = {η}_{i} \cdot \frac{{I}_{i}}{{A}_{i}}$$

where ηᵢ is the efficiency of the device in units of cd/A.

The colour ratios are defined by: α_{R}:α_{G}:α_{B}

That is, a defines the weight factor for the respective colour, or in other words: of the total light emitted by a colour pixel a fraction a is emitted by the one of the sub-pixels. Hence we find that:

$${B}_{i} = {α}_{i} \frac{{B}_{0} {A}_{0}}{{A}_{i}} = {γ}_{i} \cdot \frac{{η}_{i}}{{T}_{i}}$$

which leads to:

$${T}_{i} = \frac{{γ}_{i} {η}_{i} {A}_{i}}{{α}_{i} {B}_{0} {A}_{0}}$$

We want all the pixels to decay in the same time, so setting all lifetimes equivalent leads to the relation for the areas as in:

$$\frac{{γ}_{R} {η}_{R} {A}_{R}}{{α}_{R}} = \frac{{γ}_{G} {η}_{G} {A}_{G}}{{α}_{G}} = \frac{{γ}_{B} {η}_{B} {A}_{B}}{{α}_{B}}$$

This last equation only contains material parameters which can be measured on a manufactured device, and for any two sub-pixels, denoted by numeral 1 and 2, the area ratio can hence be written as:

$$\frac{{A}_{1}}{{A}_{2}} = \frac{{γ}_{2}}{{γ}_{1}} \cdot \frac{{η}_{2}}{{η}_{1}} \cdot \frac{{α}_{1}}{{α}_{2}}$$

Hence, to summarize, an electroluminescent device for use, e.g., in a colour matrix display unit is presented. Picture elements comprise a plurality of electroluminescent sub-pixels capable of emitting light when subject to electric current. The sub-pixels each have a degradation lifetime and an emissive area and, for any pair of first and second sub-pixels in a picture element, the ratio between the first sub-pixel emissive area and the second sub-pixel emissive area is inversely proportional to the ratio between the degradation lifetime of said first sub-pixel and the degradation lifetime of the second sub-pixel.

1. Electroluminescent device (100, 200, 300) comprising at least one picture element (110, 200, 300), said at least one picture element comprising a plurality of electroluminescent sub-pixels (201, 202, 203, 301, 302, 304) capable of emitting light when subject to electric current, the sub-pixels each having a degradation lifetime and an emissive area, characterized in that, for any pair of first and second sub-pixels in a picture element, the ratio between the first sub-pixel emissive area and the second sub-pixel emissive area is inversely proportional to the ratio between the degradation lifetime of said first sub-pixel and the degradation lifetime of the second sub-pixel.

2. Device as claimed in claim 1, where any of said sub-pixel emissive areas comprises a plurality of discrete emissive area parts (303, 305).

3. Device as claimed in claim 1, where said ratio between the first sub-pixel emissive area (A₁) and the second sub-pixel emissive area (A₂) follows the relation:
$$\frac{{A}_{1}}{{A}_{2}} = \frac{{γ}_{2}}{{γ}_{1}} \cdot \frac{{η}_{2}}{{η}_{1}} \cdot \frac{{α}_{1}}{{α}_{2}}$$
where γ, η and α, with index 1 representing the first sub-pixel and index 2 representing the second sub-pixel, are respective measurable material parameters, where η represents the efficiency of conversion of electric current to light, γ is a scaling factor depending on the efficiency, brightness and lifetime, and α is, in units of total output light by the picture element, the fraction emitted by the respective sub-pixel.

4. Device as claimed in claim 1, where said at least one picture element comprises three sub-pixels, said sub-pixels being denoted R-, G- and B-sub-pixel, respectively, and where the relation between the areas A_{R}, A_{G} and A_{R} of respective R-, G- and B-sub-pixels follows from the relation:
$$\frac{{γ}_{R} {η}_{R} {A}_{R}}{{α}_{R}} = \frac{{γ}_{G} {η}_{G} {A}_{G}}{{α}_{G}} = \frac{{γ}_{B} {η}_{B} {A}_{B}}{{α}_{B}}$$

5. Device as claimed in claim 1, where the sub-pixels comprise electroluminescent organic material.

6. Device as claimed in claim 5, where the organic material includes electroluminescent polymer.

7. Device as claimed in claim 5, where the organic material includes electroluminescent low molecular weight material.

8. Device as claimed in claim 1, where the sub-pixels comprise electroluminescent inorganic material.

9. Device as claimed in claim 1, where the at least one picture element is arranged to provide illumination.

10. Device as claimed in claim 1, where the at least one picture element is arranged in a matrix (101) configuration in a colour display unit.
